(19) United States
(12) Patent Application Publication
(10) Pub. No.: US 2015/0298496 A1
(43) Pub. Date: Oct. 22, 2015

(54) "The Paint Can-dle"™ detachable, adjustable utility handle for quart size paint cans

(71) Applicant: Thomas M. Payne, Tappan, NY (US)

(72) Inventor: Thomas M. Payne, Tappan, NY (US)

(21) Appl. No.: 14/255,024

(22) Filed: Apr. 17, 2014

(51) Int. Cl. B44D 3/14; B65D 25/28; B44D 3/12

(52) U.S. Cl. CPC B44D 3/14; B44D 3/128; B65D 25/28; B65D 2525/285

(57) ABSTRACT

The “Paint Can-dle™” is a unique, reusable, adjustable and versatile handle for quart size paint cans and more. Conventional pint and quart paint cans are typically sold without handles and while the pint size is easy enough for most people to handle, the quart size is larger and heavier which, when held for extended periods, often causes hand cramps and fatigue for many users. This inventive tool is comprised of a rigid handle, sized for quart paint cans, which attaches to a container with Velcro® like straps without need for bottom support. The handle includes a magnet for holding brushes etc. and the design allows can lids to be opened and closed while it is so attached, making the can easier and safer for everyone to handle, especially those with small hands or limited gripping ability.

### BACKGROUND OF THE INVENTION

1. Field of the Invention

The present invention relates generally to detachable handles for commercial quart size paint containers. More particularly, the present invention relates to detachable handles which do not make use of top or bottom rims for attachment.

2. Summary of Prior Art

The plurality of prior art over many years demonstrates the long standing desire and need for a detachable container handle which readily and securely attaches to one or more size containers such as conventional quart paint cans or coffee cans and which is not complex, is light weight, simple and comfortable to use and permits can lids to be removed and replaced while the handle is attached. Many painting accessories have been created that; for the most part, address problems other than painting from a quart size can for long periods. A search of prior art did not disclose any patents that read directly on the claims of the instant invention; however, examples follow which were considered related.

### DESCRIPTION RELATING TO PRIOR ART

Subject matter discussed in the background section may or may not be prior art and may merely represent different approaches to solving past and current problems incurred when painting from commercial quart size paint cans.

Various prior art types of detachable handles have been provided which releasably attach to a paint can's rims for carrying the paint can and for pouring paint from the paint can.

Drawbacks with the above-noted detachable handles such as disclosed in Robuck, Lockwood, Hoffman, Niemeier, and Scace which are adjustably attachable to various sized paint cans include, that if the rotatable screw or the screw/wing nut assembly loosens, the handle may detach from the paint can. These handles need to attach to the rims of containers which impedes operation of the container lid.

Both are particularly undesirable when carrying the paint can by the detachable handle and limits usability of function in other applications.

For example, U.S. Pat. No. 2,905,500 to Thombs discloses a detachable handle adapted for use with a paint can. The detachable handle includes a frame having a jaw member which engages a bottom rim of the paint can, and a movable jaw member which releasably attaches to the frame and engages a top rim of the paint can. The movable jaw member and the frame are fixedly attached to each other with a screw and wing nut. In particular, the screw extends through vertically aligned holes in the movable jaw member and the frame.

Another drawback of the detachable handle disclosed in Thombs is that the handle is sized only for attachment to a single sized container.

Other detachable handles adapted for use with a paint can have been devised which are releasably attachable to various sized paint cans. For examples, U.S. Pat. No. 2,010,317 to Olson discloses a detachable handle having a fixed jaw member, a movable jaw member, and a vertically extending spring for biasing the jaw members toward each other to clampingly engage the top and bottom rims of a paint can. A drawback with the detachable handle disclosed in Olson is that the detachable handle is not fixedly attached to the paint can and is susceptible to disengagement from the paint can.

Another example of a detachable handle adapted for attaching to various sized paint cans is U.S. Pat. No. 2,808,285 to Robuck. Robuck discloses a detachable handle having first and second jaw members, and a generally vertically extending screw-threaded member which is rotated to adjust the spacing between the jaw members to clampingly engage the top and bottom rims of a paint can.

U.S. Pat. No. 3,024,057 to Lockwood discloses a detachable handle having a pair of jaw members, one of which includes a vertically extending slot, through which a screw/wing nut assembly is used to adjust the spacing between the jaw members to clampingly engage the top and bottom rims of various sized paint cans. See also U.S. Pat. No. 2,613,860 to Hoffman and U.S. Pat. No. 5,584,520 to Niemeier.

U.S. Pat. No. 6,102,458 to Scace; Stuart A. (Pittsfield, Mass.) discloses a detachable handle which is readily fixed in size for securely attaching to a standard sized container, . . . . The container engaging portions are engageable with the top rim and the bottom rim, respectively, of the standard sized container.

U.S. Pat. No. 7,604,270 B1 to McCarthy also uses a spring loaded handle attached to can rims. Other patents of interest include U.S. Pat. No. 3,794,370 to Lockhart which describes a solid handle with two straps which become permanently attached to a thermos bottle.

U.S. Pat. No. 6,729,665 B1 to Posey comes close in concept to the current invention but is designed and sized for quart and larger beverage bottles, does not include a magnet for paint tools, is of specific design with arpetures to locate straps and generic securing methods.

### OBJECT OF THIS INVENTION

It is the object of this invention to provide a handle for quart size paint cans and the like that is light weight, easy to use and transfer from one container to another, is comfortable to hold for long periods, is without bottom protrusions which prevent handled containers from sitting flat on a surface when not being held or prevent the handle from laying flat against tall containers or items and strong enough to be used for other applications such as a hook for tools and a carry handle for awkward items ie. small ladders, lengths of loose pipe, molding and the like. The handle must have a magnet incorporated in the body in order to hold a brush or other tool and must allow container lids to be removed and replaced while attached to said container. This invention may provide a brush wiping surface attachable to multiple containers and a means for attaching the container to a painters waistband such as a holster; and further, to a ladder providing safer ladder operations. The present invention addresses and satisfies the needs set forth in this section.

### BRIEF SUMMARY OF THE INVENTION

The “Paint Can-dle™” is a unique, reusable, adjustable and versatile handle for quart size paint cans and more. You can paint right from the can and store remaining paint in the same container, hang the can on your hip, carry your step ladder or hang tools/cables.

This unique product is comprised of a rigid handle with custom designed adjustable straps. The use of multiple straps negates the need for a bottom support, and allows the handle to be attached at balance positions on tall objects. The users hand can be slipped between the “grip” and “base,” or hold the “grip” portion alone. Another embodiment makes use of a two piece ridged handle whereby the grip portion is allowed to pivot at the neck section and be fixed in selected positions angling away from its normal, parallel to the base, position.

A “brush magnet” holds the brush above the can and a movable “tool magnet” may be used to hold small tools, the can lid, opener or other accessories. A tape ruler might be clipped on a vertical “Spanner” strip. Use of the handle on a container having it's own lid allows for temporary covering when not in use, and sealing for storage. The anterior or contact surface is provided with a slip resistant compression able pad of a foam rubber type material which creates space between the rigid handle and the container while aiding the straps to tighten securely. A separate brush and tool wipe half lid might be used as desired.

The handle also accepts propane torches, coffee cans, beverage bottles and like containers.

### Perceived User Benefits of Instant Invention:

1. “Comfortable control for better results”™ with less fatigue, fewer hand cramps and longer work time.

2. Faster start and finish time; attach handle, open can, paint, close can, clean brush. Use and store in same container with nothing else to clean or throw away.

3. Makes for easier brush cleaning which promotes quality brush use for easier painting and better results. Tool magnet allows a cleaned brush to dry with bristles down and maintain shape.

4. Use of a holster such as is available for a utility knife: safer carrying up and down ladders, use two hands with open/closed container. Painting from a waist mounted can allows holding the project with one hand while painting with the other without bending.

5. Attached to ladder, it allows paint to be moved with the ladder when cutting in or trim painting. You don't need to carry the paint each time you go up and down to move the ladder.

6. Magnet brush holder lets you carry a wet brush up and down ladders, holds the brush while you tape lines or wipe mistakes.

7. Tool magnet allows can lid and opener to be kept with the can for opening and closing while on the ladder.

8. As a handle: Easier carry of awkward items i.e.: Propane torch, step ladder, pipe bundle, molding etc., large beverage bottles, cold or hot containers, children's crayons etc. Especially useful for people with small hands or limited hand strength or control, i.e. arthritis etc.

9. As a movable hook; allows cables, tools, hoses or supplies to be kept at hand while working on ladders, freeing hands for safer operations.

10. Hanging tools, sanders, nail-screw guns, etc. on a ladder eliminates much back bending as when putting tools down and picking up allowing holding the project and reaching for the tool.

11. Carry empty coffee cans of small parts, paint, joint compound, patching material, etc.

As this tool will be used for purposes other than as specified or suggested; the preferred embodiments show only major variations of the invention which may be adapted in size, shape, color and arrangement of parts to meet other uses. These descriptions and drawings should not limit the scope and spirit of this invention.

### BRIEF DESCRIPTION OF THE DRAWINGS

The following drawings and detailed description are proffered to aid in the understanding of the current invention. Like elements of the description and drawings are identified with like symbols and in which:

FIG. 1 is a perspective view of the handle prior to being attached to a container and showing a grip portion, an imbedded brush magnet, a slip-resistant surface attached to the curvilinear inner surface, two surrounding straps, one of which is open while the other is in a closed position and a vertical “Spanner strip” separating the straps.

FIG. 2 A shows the handle in profile, or side view showing the ergonomic grip and hand rest portion of the neck section, the brush magnet location slanting downward and the strap locating Velcro® like loop strip in position on the back of the base section as well as the hanging aperture in the grip.

FIG. 2B is a top view of the invention illustrating the curvilinear anterior contact surface, brush magnet and slip-resistant surface.

FIG. 3 shows an alternate style surrounding strap which utilizes a buckle like closure and Velcro® like hook material affixed to the inner surface as an aid in positioning said strap along the handle base.

FIG. 4a shows an alternative embodiment of an essentially “D” shaped closed handle using the same brush magnet, anti-slip pad and straps. In another embodiment shown in FIG. 4b, the grip portion of said “D” handle might be pivoted at the neck portion and have locking methods, such as a wing nut and bolt or the like, located at the pivot and bottom of said grip and base portions. This arrangement would allow said grip to be levered upward and held at various angles to the base in a variety of preferred holding positions or locked at said base for improved lifting performance.

FIG. 5 shows an optional use semi-circular brush wipe tool which attaches to said paint and coffee cans with a snap fit.

### DETAILED DESCRIPTION OF THE INVENTION, DRAWINGS AND OPERATION

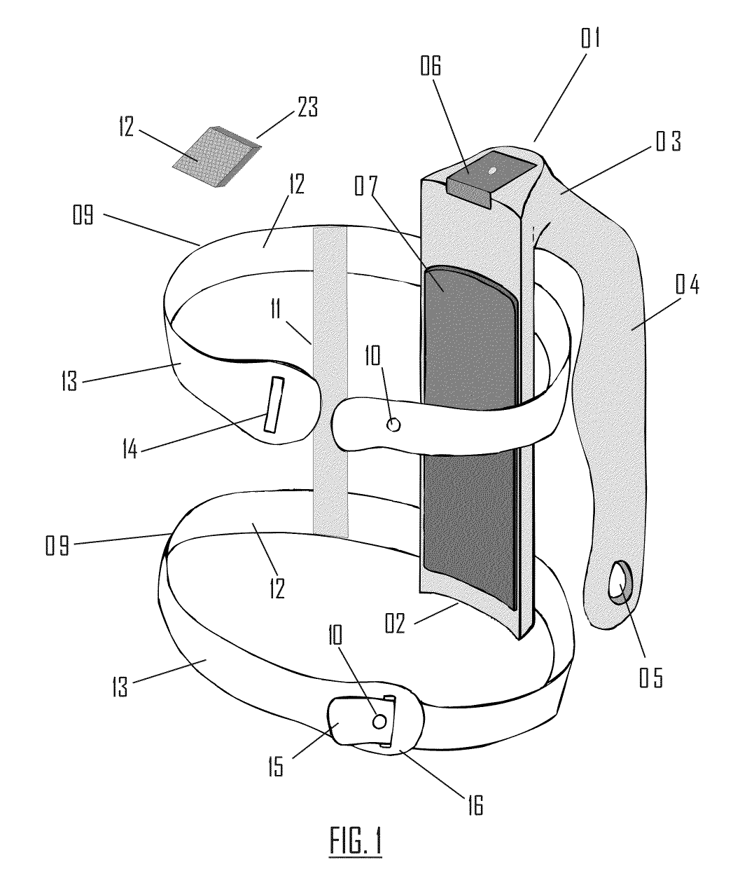

The preferred embodiment of this invention is presented in drawing figure FIG. 1 which shows the container securing straps 09 of handle unit 01 detachably affixed in open and closed configurations and the indicating hole 10 as located on both straps. The inside surface 12 of said straps being of hook material and the outside 13 of loop material. A “Spanner” strip 11 of hook/loop material is shown separating straps 09. An auxiliary Tool Magnet 23 having Velcro® like hook material 12 on one surface is shown which, in use, might be located as desired along any exposed straps loop 13 surface.

Also shown in FIG. 1 are the contact portion of base 02, neck portion 03, grip portion 04, hanger aperture 05, brush magnet 06, slip resistant pad 07, strap slot 14, “tail” or narrow strap end 15 and “head” or wide strap end 16.

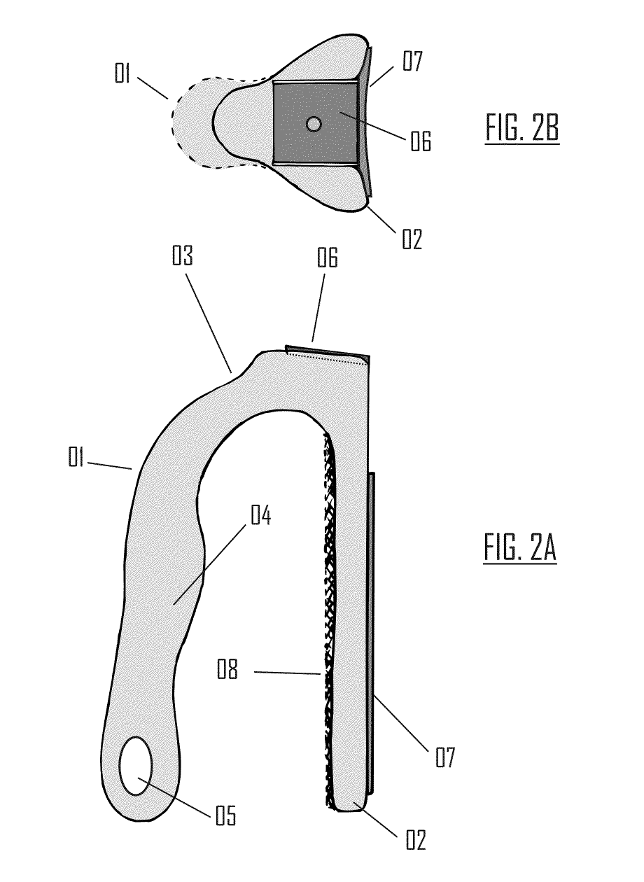

In FIG. 2A, the location of a Velcro® type self adhering loop strap locating Strip 08, to which straps 09 are detachably affixed, is shown.

FIG. 2B is a top view of handle 01 showing the curvilinear contact surface 02 and pad 07. In use, the straps 09 of handle unit 01 would be placed over or around a container so that said straps wrap around said container, the narrow end 15 of one strap 09 is passed through slot 14 of the same strap and, an end being held between the fingers of each hand, pulled tight and secured one strap surface 13 to one strap surface 12. The same procedure would be performed on the second strap 09.

In use on a paint can, pad 07 provides a standoff between the can and the curvilinear base portion 02 allowing the can's lid to be opened and closed with the handle unit 01 attached.

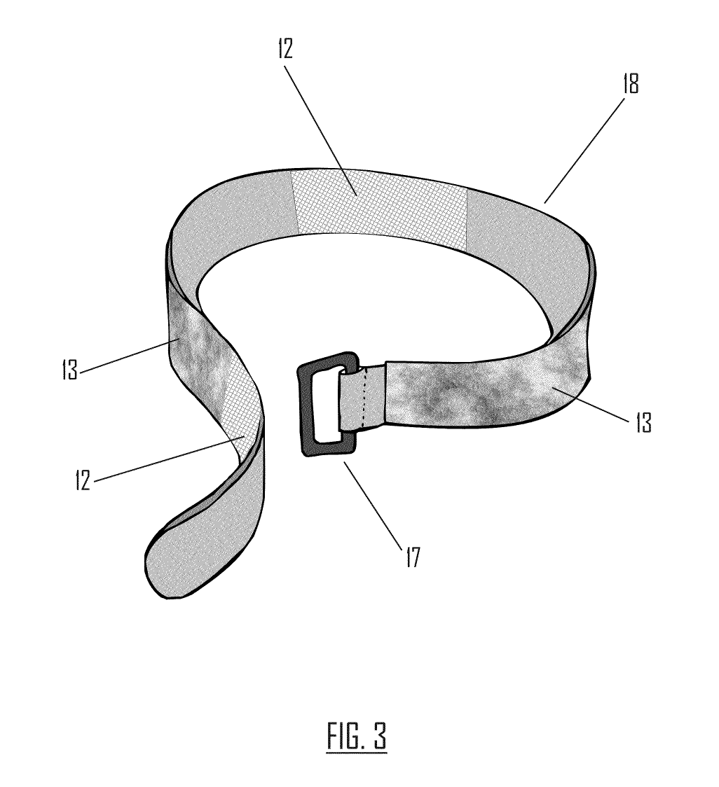

In an alternative embodiment, alternate straps 18 as shown in FIG. 3 would be used in place of straps 09. In this case, the loose strap end is passed through rectangular ring or buckle 17, folded back upon itself, pulled tight and adhered hook side 12 to loop surface 13. All other unit operations remain the same.

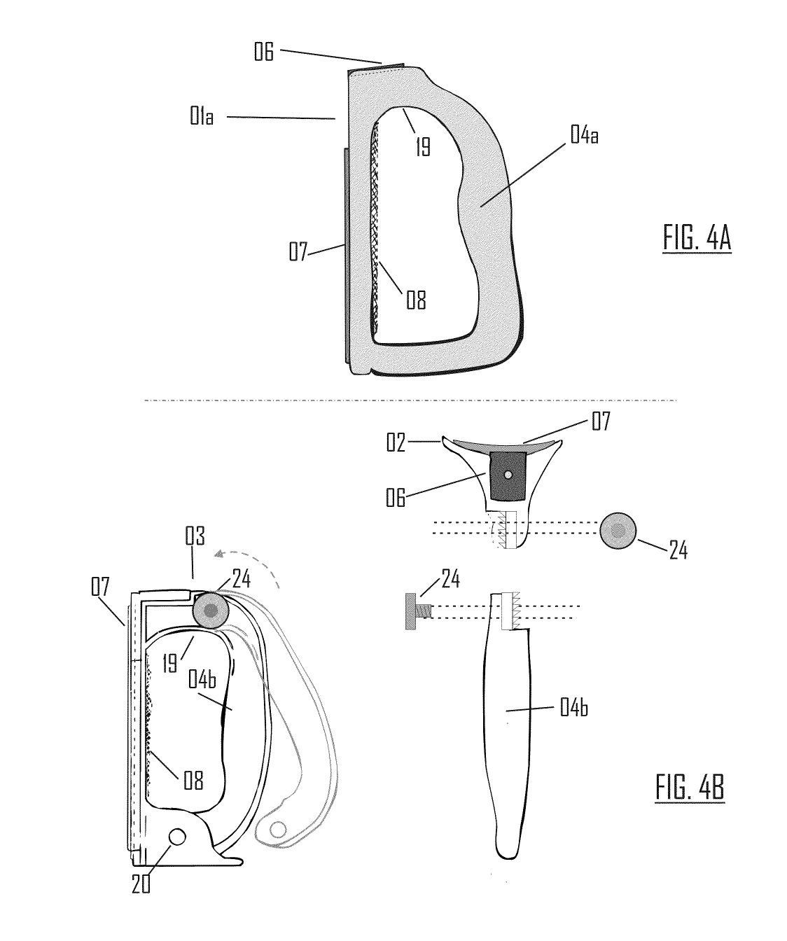

Another embodiment shown in FIG. 4A illustrates the ridged grip portion 04(a) of an essentially closed, “D” shape, handle using the same Brush magnet 06, anti-slip pad 07 and locating strip 08 of handle unit 01. A second embodiment FIG. 4B of said handle might be a two piece base 02(b) and grip 04(b) where said grip is pivoted 24 and fixed at the neck portion 03 and having a lower grip locking method 20, such as a nut and bolt or the like, located at the bottom of said grip and base portions. This arrangement would allow said grip 04(b) to be levered upward and held at various angles to said base in a variety of preferred holding positions or locked at said base for improved lifting performance.

In the embodiments shown, the user might hold the handle by grip 04 or hang the handle on an open hand slipped between grip 04 and base 02 with hand rest portion 19 over the users open hand web.

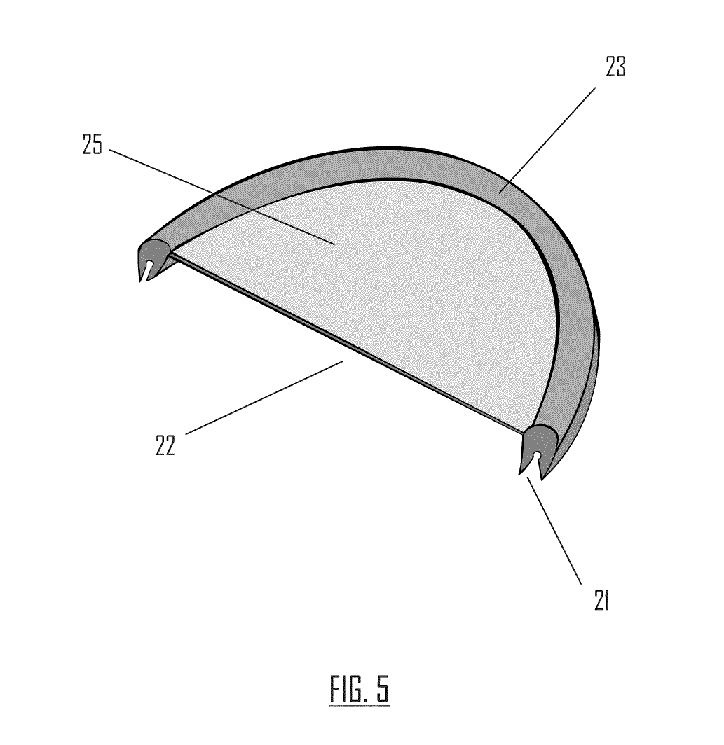

If desired by the user, the Brush Wipe 25 accessory of FIG. 5 might be snapped on a can rim using the gripping lip 21 provided and the wipe edge 22 to remove excess paint from a brush, allowing berm 23 to direct excess paint back into said can. This Brush wipe piece is similar in design to expired design patent U.S. Pat. No. D305,820 and should not be considered part of the current invention.

When used as a hook or hanging device; handle 01 is strapped, with the grip end pointing upward, about a ladder upright, an upright post or the like rather than to a container. (Not shown.)

When used as a carry handle, handle 01 is strapped around the balance point of the object to be carried. (Not shown.)

DESCRIPTION OF NUMBERED ITEMS IN DRAWINGS

01, 01a, 01b handle
02 contact portion of base
03 neck portion
04, 04a, 04b grips
05 hanger aperture
06 Brush Magnet
07 slip resistant pad
08 Locating strip
09 securing strap
10 indicating hole
11 Spanner strip
12 strap hook surface
13 strap loop surface
14 strap slot
15 narrow strap end
16 Strap “head” or wide end
17 buckle
18 alternate strap
19 hand rest portion
20 grip locking method
21 wipe gripping lip
22 brush wipe edge
23 Tool Magnet
24 pivot
25 Brush Wipe

1. An ergonomic detachable, adjustable handle for holding and transporting a quart size paint can and similar size containers comprising: a molded structural plastic or similar ridged material having a grip portion with a textured surface angled downward and outward from the top portion of a curvilinear base section which is contoured for contact with said cylindrical can and of a vertical height extending above said paint can and;
A) having a slip resistant flexible pad affixed to said curvilinear face or contact surface, and
B) a magnet affixed into the top, or neck, of said handle with
C) One or more custom designed Velcro One Wrap® like hook and loop straps to surround and hold said container to said handle and a separate hook and loop strap separator strip and,
D) having a separate brush wipe piece.

2. The molded handle of claim 1 wherein said handle base or vertical contact surface extending sufficiently above the height of common quart size paint cans to allow said magnet to be imbedded or affixed in top of said handle unit and the back of said base having a self-adhesive Velcro® type loop material strip applied in order to hold the hook side of said surrounding straps in position, and
A) said straps being made of custom designed Velcro One Wrap® like two sided hook and loop fabric having a head or wide end having a slot cut through the material to allow the tail, or narrow end, to pass through and self adhere, hook to loop in order to secure said surround and which said narrow end has a small aperture indicating when one full square inch of hook to loop contact can be made and full tensile strength has been achieved on the completed strap surround, and said straps may be of fire retardant material and,
B) said straps of another embodiment being of modified Velcro® like material utilizing a “D” ring type buckle fastener or similar device, and
C) said modified straps having Velcro® hook type material attached to the inner side for adhering to the loop positioning strip on the back side of said handle base.

3. In another embodiment, an ergonomic detachable, adjustable handle for holding and transporting a quart size paint can and similar size containers comprising: a molded structural plastic or similar ridged material having a grip portion with a textured surface and is shaped similar to the letter “D”. The grip section of said handle depending outward from the top portion of a curvilinear base section and curving to connect with the lower section of said base section which is contoured for contact with said cylindrical can and of a vertical height extending above said paint can and;
A) having a slip resistant flexible pad affixed to it's curvilinear face or contact surface, and
B) a magnet imbedded into the top, or neck, of said handle with,
C) a pair of custom designed Velcro One Wrap® like hook and loop straps to surround and hold said container in place and,
D) a Velcro® like loop strap locating strip fixedly attached to said grip side of said base.

4. The handle of claim 3 being of two piece construction comprising a curvilinear base section and a separate grip section designed to pivot and lock outwards from the top or neck portion and having a lower grip locking method, such as a nut and bolt or the like, located at the bottom of said grip and base portions and,
A) having a slip resistant flexible pad affixed to it's curvilinear face or contact surface, and,
B) a magnet imbedded into the top, or neck portion, of said handle with,
C) a pair of custom designed Velcro One Wrap® like hook and loop straps to surround and hold said container in place and,
D) a Velcro® like loop strap locating strip fixedly attached to said grip side of said base and,
E) a protrusion on the bottom rear of said base extending outward and under said grip portion of such dimension as to allow use as a grip locking point and a paint can opener.
